(19) United States
(12) Patent Application Publication
(10) Pub. No.: US 2005/0064973 A1
(43) Pub. Date: Mar. 24, 2005

(54) Sprayer with interchangeable power sources

(76) Inventors: James C Schroeder, Ramsey, MN (US); Robert J Lind, Robbinsdale, MN (US); Michael J Jens, Minneapolis, MN (US); Neil A Taylor, Elk River, MN (US)

Correspondence Address: Douglas B Farrow;Corporate Intellectual Property, Graco Minnesota Inc., P O Box 1441, Minneapolis, MN, 55440-1441, US

(21) Appl. No.: 10/498,199

(22) PCT Filed: Jan. 14, 2003
(86) PCT No.: PCT/US03/01046

Related U.S. Application Data
(60) Provisional application No. 60/349,149, filed on Jan. 15, 2002.

(51) Int. Cl. F16H 55/12; F16H 55/36

(52) U.S. Cl. 474/174; 474/151

(57) ABSTRACT

There are several components on the convertible gas/electric sprayer (12) that facilitate the easy electric motor/gas engine conversion and positioning of the pulley (18) to the drive belt (20) for loading and unloading. The pulley for the gas engine and the pulley for the electric motor have two features that help guide the drive belt (20) onto the pulley (18). The lead in angle (18A) on the front of the pulley (18) helps the belt (20) over the front of the pulley (18). The backstop lip (18C) on the rear of the pulleys prevents the belt (20) from overshooting the V-groove (18D). The fingers (22A) on the upper portion of the bracket hold the belt on the upper drive pulley during conversion and shape the belt to accept the drive pulley, and the rib (22B) on the bracket holds the belt in position to accept the pulley during loading.

### TECHNICAL FIELD

This application claims the benefit of US application serial number ______, filed ______.

### BACKGROUND ART

Airless sprayers having interchangeable power sources (between gas and electric motors) have been popular in the contractor market. While existing units have of course been functional, it is always desirable to improve on the ease of power source interchange.

### DISCLOSURE OF THE INVENTION

It is therefore an object of this invention to provide a gas/electric convertible sprayer which allows quick and easy interchange of the power units and which requires minimal effort on the part of the operator to align the various components.

There are several components on the instant invention that facilitate the easy electric motor/gas engine conversion and positioning of the pulley to the drive belt for loading and unloading. The pulley for the gas engine and the pulley for the electric motor have two features that help guide the drive belt onto the pulley. The lead in angle on the front of the pulley helps the belt over the front of the pulley. The backstop lip on the rear of the pulleys prevents the belt from overshooting the V-groove.

The belt guide bracket has two features that facilitate the easy electric motor/gas engine conversion. The fingers on the upper portion of the bracket hold the belt on the upper drive pulley during conversion and shape the belt to accept the drive pulley. The rib on the bracket holds the belt in position to accept the pulley during loading. The belt guard holds the belt in position during unloading.

The motor/engine base along with the frame have features that guide the base on the frame and limit the total rotation of the base on the frame to guide the pulley to the drive belt. The base has a lip that works with a “shelf” feature on the frame to prevent the over rotation of the base. The “finger” feature on the frame prevents the under rotation of the base. The rotation of the base to the proper position allows the proper belt engagement to the pulley. The frame also has a shoe that accepts the motor/engine base during conversion and stabilizes the base.

The tension bar and bracket apply a constant tension to the belt to prevent slipping during operation. The design of the tension bar also allows the motor/engine base to float. The tension bar and bracket are designed to work together to facilitate quick load/unload electric motor/gas engine conversion.

The handles are ergonomically designed to lift, rotate, and move the motor/engine base for easy conversion.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is front perspective partially exploded view of the instant invention with a gasoline engine.

FIG. 2 is rear perspective partially exploded view of the instant invention with a gasoline engine.

FIG. 3 is side partially exploded view of the instant invention with a gasoline engine.

FIG. 4 is side view of the instant invention with a gasoline engine.

FIG. 5 shows the main subassemblies and combinations thereof.

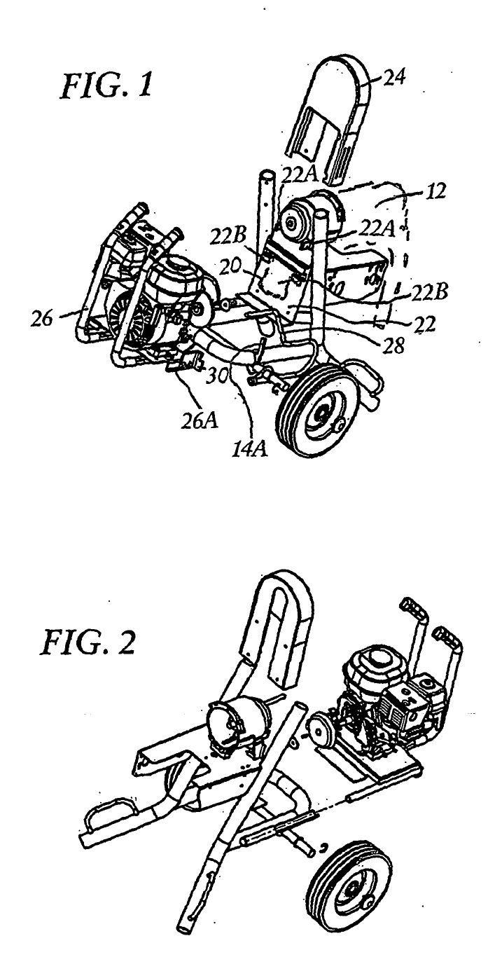

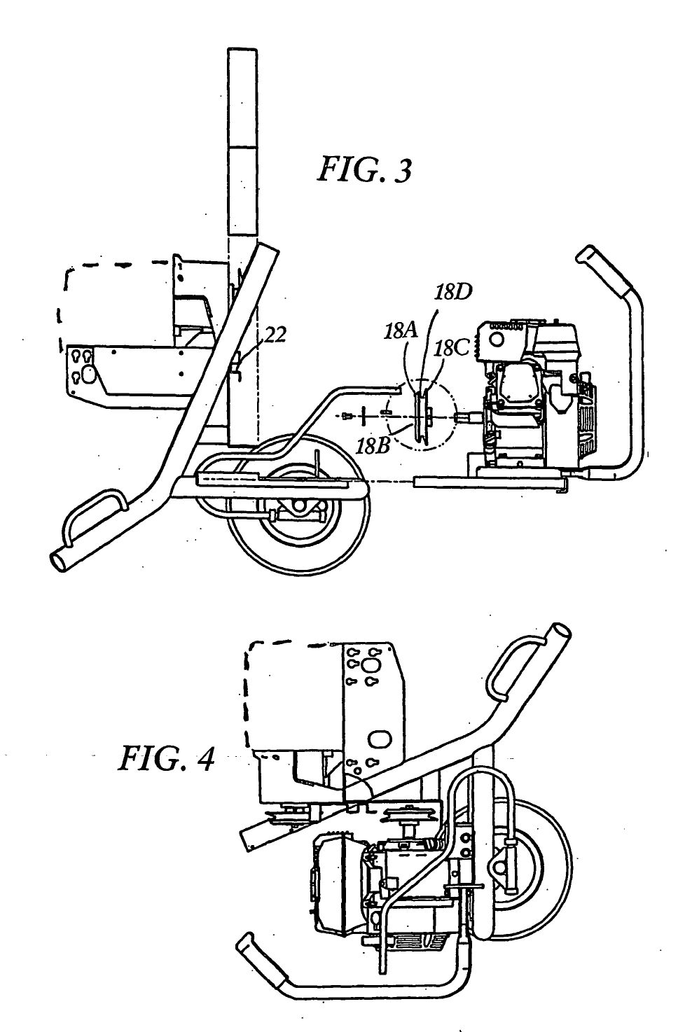

### BEST MODE FOR CARRYING OUT THE INVENTION

The instant invention, generally designated 10 is comprised of an airless sprayer 12 mounted on a frame 14 and has a clutch assembly 16 having a pulley 18 thereon. There are several components on the instant invention that facilitate the easy electric motor/gas engine conversion and positioning of the pulley 18 to the drive belt 20 for loading and unloading. The pulley 18 for the gas engine and for the electric motor have two features that help guide the drive belt onto the pulley. The lead in angle 18A on the front 18B of the pulley helps the belt 20 over the front of the pulley 18. The backstop lip 18C on the rear of the pulleys 18 prevents the belt 20 from overshooting the V-groove 18D.

The belt guide bracket 22 has two features that facilitate the easy electric motor/gas engine conversion. The fingers 22A on the upper portion of the bracket hold the belt on the upper drive pulley during conversion and shape the belt to accept the drive pulley. The rib 22B on the bracket holds the belt in position to accept the pulley during loading. The belt guard 24 holds the belt in position during unloading.

The motor/engine base 26 along with the frame 14 have features that guide the base 26 on the frame 14 and limit the total rotation of the base 26 on the frame 14 to guide the pulley 18 to the drive belt 20. The base 26 has a lip 26A that works with a shelf 14A on the frame 14 to prevent the over rotation of the base 26. The “finger” feature on the frame prevents the under rotation of the base. The rotation of the base to the proper position allows the proper belt engagement to the pulley. The frame also has a shoe 14B that accepts the motor/engine base guide rod 26B during conversion and stabilizes the base 26.

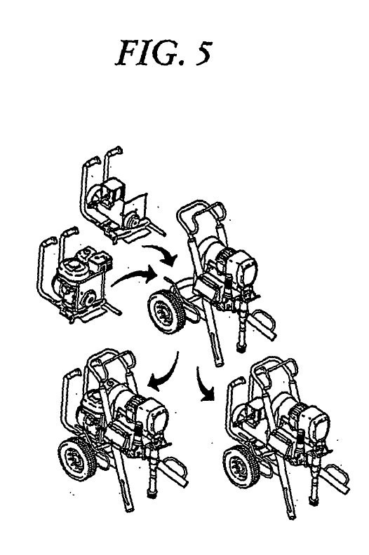

The tension bar 28 and bracket 30 apply a constant tension to the belt to prevent slipping during operation. The design of the tension bar 28 also allows the motor/engine base 26 to float. The tension bar 28 and bracket 30 are designed to work together to facilitate quick load/unload electric motor/gas engine conversion. FIG. 5 shows both the gas and electric motor/base combinations.

The handles are ergonomically designed to lift, rotate, and move the motor/engine base for easy conversion.

It is contemplated that various changes and modifications may be made to the convertible sprayer without departing from the spirit and scope of the invention as defined by the following claims.

1. In an airless sprayer having a frame and interchangeable power sources, each said power source having a V-groove pulley thereon for engagement with a drive belt, the improvement comprising each said pulley comprising:
a lead in angle on the front of the pulley to help said drive belt over the front of said pulley; and
a backstop lip on the rear of said pulley prevents said drive belt from overshooting the V-groove on said pulley.

2. In an airless sprayer having a frame and interchangeable power sources, each said power source having a V-groove pulley thereon for engagement with a drive belt, the improvement comprising a belt guide bracket comprising a plurality of fingers on the upper portion of said bracket to hold the belt on the upper drive pulley during conversion and shape the belt to accept the drive pulley, and a rib on said bracket to hold the belt in position to accept said pulley during loading.
